(19) United States
(12) Patent Application Publication
(10) Pub. No.: US 2005/0023375 A1
(43) Pub. Date: Feb. 3, 2005

(54) Lawn sprinkler grass guard

(76) Inventor: Oswald Tanczos, Westminster, CA (US)

Correspondence Address: Karl M. Steins;Steins & Associates, Suite 120, 2333 Camino del Rio South, San Diego, CA, 92108, US

(21) Appl. No.: 10/634,017

(22) Filed: Aug. 2, 2003

(51) Int. Cl. B05B 15/06

(52) U.S. Cl. 239/288; 239/288.3; 239/288.5; 239/201; 239/203

(57) ABSTRACT

A Lawn Sprinkler Grass Guard is disclosed. Also disclosed is a guard that attachs to a conventional sprinkler to prevent grass from growing too closely to the sprinkler. The guard is further designed such that it is easily attached and detached from sprinklers. The guard also includes an inner sleeve having a bore for accepting a sprinkler therethrough. The guard has a sloped top to allow for ease of clamp installation. Finally, the guard is available in full-circle, half-circle, and quarter-circle versions.

### BACKGROUND OF THE INVENTION

1. Field of the Invention

This invention relates generally to tamper-proof seals for containers and, more specifically, to a Lawn Sprinkler Grass Guard.

2. Description of Related Art

Nearly all single family homes constructed today in the United States have irrigation system in order to assist in the proper maintenance of the lawn and other foliage. Many owners of existing homes have recognized the benefits of the installed irrigation system, and also have undertaken to retrofit their yard with below-ground irrigation systems.

FIGS. 1A and 1B depict a conventional “popup” sprinkler 10. When at rest (i.e. when not sprinkling), the sprinkler 10 appears as in FIG. 1A. The can 12 has been placed below the dirt 16 and connected to a water supply pipe at its bottom (not shown). The sprinkler or popup assembly 14 is attached to the can 12 such that it is at or near the level of the turf 18. As depicted in FIG. 1B, when the irrigation system is activated, the water pressure causes the stem 22 to pop up and extend upwardly from the can 12. The stem 22 terminates at its distal end in a head 24, where the water actually sprays out from. The stem 22 is attached to the can 12 by the cap 20 screwed thereto.

One recurring problem with the below-ground systems is that when the sprinkler is activated, and the stem 22 has not yet extended, water tends to spray out through the head 24 while the head 24 is still at the level of the turf 18. This repeated spraying causes the turf 18 to be damaged and unsightly. What is needed is a device that will protect the turf surrounding a popup sprinkler 10 from spray damage; it would also be desirable if the device was aesthetically pleasing.

### SUMMARY OF THE INVENTION

In light of the aforementioned problems associated with the prior devices, it is an object of the present invention to provide a Lawn Sprinkler Grass Guard. The guard should attach to a conventional sprinkler to prevent grass from growing too closely to the sprinkler. The guard should be designed such that it is easily attached and detached from sprinklers. The guard should further include an inner sleeve having a bore for accepting a sprinkler therethrough. The guard should further have a sloped top to allow for ease of clamp installation. Finally, the guard should be available in full-circle, half-circle, and quarter-circle versions.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIGS. 1A and 1B are side views of a conventional popup sprinkler;

FIG. 2 is a top exploded perspective view of a grass guard assembly of the present invention;

FIGS. 3A and 3B are cutaway side and top views, respectfully, of the grass guard of FIG. 2;

FIG. 4 is a cutaway side view of the grass guard of FIGS. 2 and 3 installed on a conventional popup sprinkler;

FIGS. 5A and 5B are top perspective and top views, respectively, of a semi-circle grass guard of the present invention; and

FIGS. 6A and 6B are top perspective and top views, respectively, of a quarter-circle grass guard of the present invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Lawn Sprinkler Grass Guard.

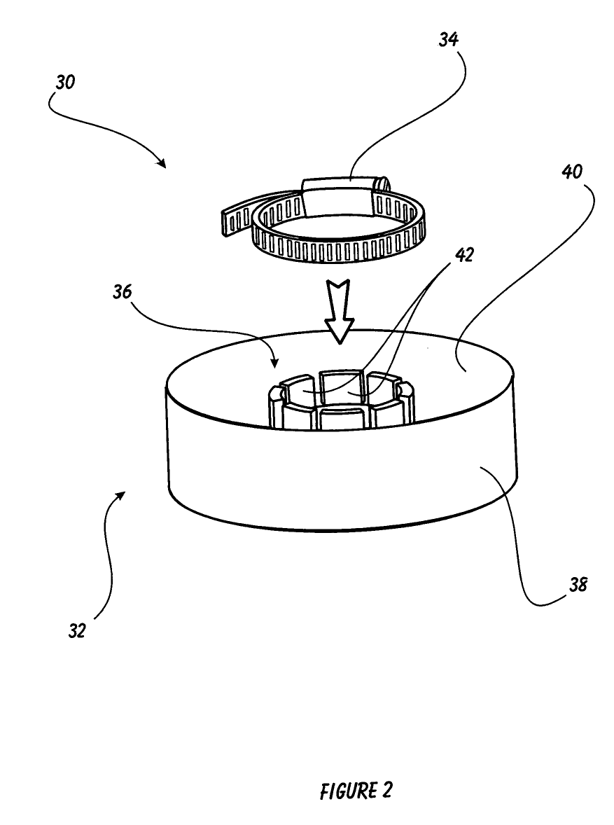

The present invention can best be understood by initial consideration of FIG. 2. FIG. 2 is a top exploded perspective view of a grass guard assembly 30 of the present invention. The assembly 30 comprises a grass guard 32 and a clamp 34 for attaching the grass guard to a sprinkler (not shown). In this embodiment, it can be seen that the guard has an outer circular wall 38 transitioning to a sloped top surface 40 to an inner sleeve 36 at the center. The inner sleeve 36 preferably is formed from a plurality of tabs 42 to allow for variation in diameters of the sprinklers to which the guard 32 is being attached.

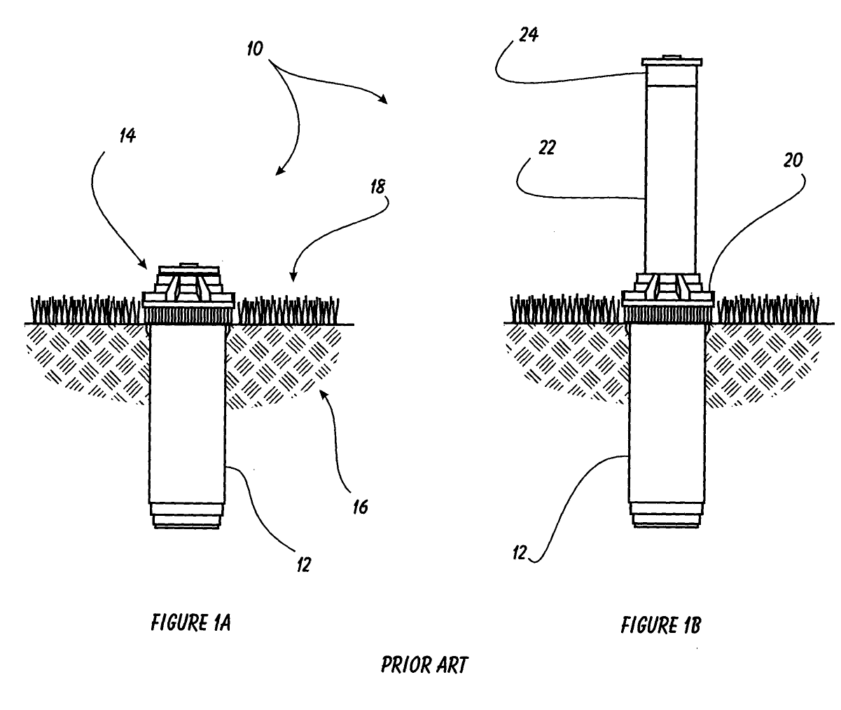

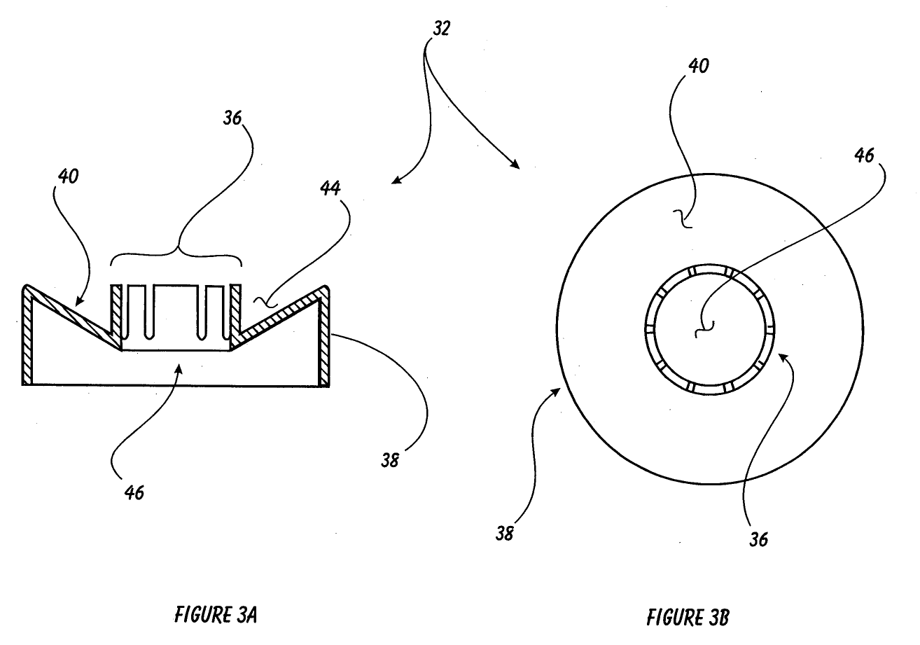

In order to use (i.e. install) the grass guard assembly 30, the user need simply slide the inner sleeve 36 over the upper end of the can (see FIG. 1). Next, the clamp 34 is slipped over the inner sleeve 36 and tightened in place. In order to make the guard 32 durable and aesthetically pleasing, it is likely that it will be constructed from green plastic (e.g. molded). The clamp 34 may be a conventional pipe clamp as shown, or may be made from rust-proof materials, such as plastic and brass. In other embodiments, the clamp 34 may be integrated into the guard as a unitary assembly (i.e. rather than being removable). Now turning to FIGS. 3A and 3B, we can further explore the details of this novel invention.

FIGS. 3A and 3B are cutaway side and top views, respectfully, of the grass guard 32 of FIG. 2. As shown, the inner sleeve 36 has a plurality of slots formed therein in order to form the tabs previously discussed. A bore 46 for accepting the sprinkler can is located at the center of the inner sleeve. A trough 44 is formed where the sloped top surface 40 intersects the base of the inner sleeve; this trough 44 permits the user to access the clamp (see FIG. 2) from atop the guard 32 when the guard 32 is installed on a sprinkler.

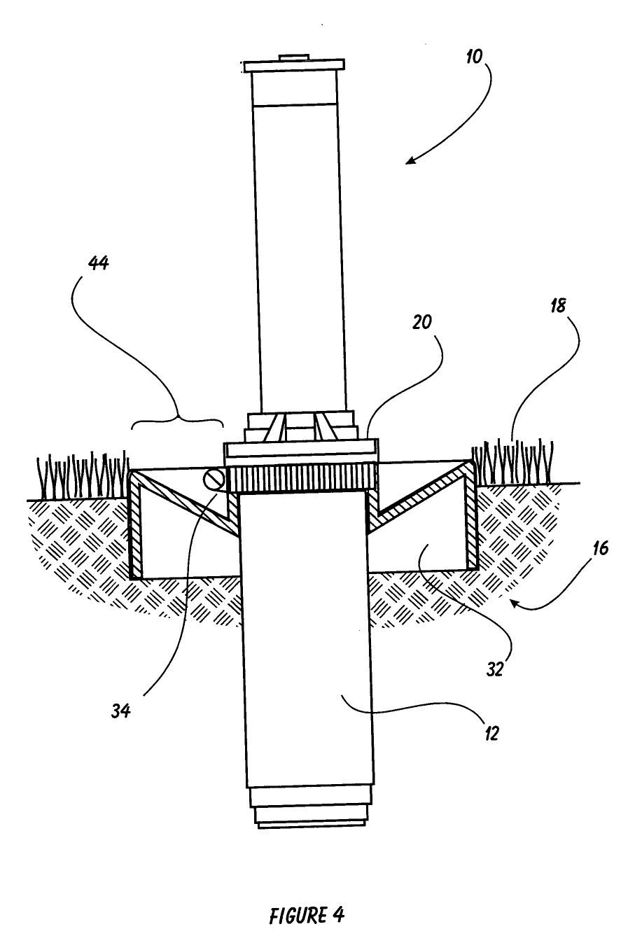

FIG. 3B depicts the guard 32 from its top; as shown, the outer wall 38 has a circular shape. This design is particularly adapted for situations when the sprinkler is installed in the dirt without any surrounding impingements, such as from a sidewalk or a wall, etc.. When there isn't anything impinging on the zone that is approximately 2½ inches in diameter from the center of the bore 46, then there is adequate room for the full circle guard 32 shown here. Since virtually all sprinklers have circular cross-sections, the bore 46 of the guard 32 also has a circular cross-section. The gap between the outer wall and the sprinkler is called an interstitial gap. Now turning to FIG. 4, we can see how the device is used.

FIG. 4 is a cutaway side view of the grass guard 32 of FIGS. 2 and 3 installed on a conventional popup sprinkler 10. As shown, the guard 32 is installed even in height with the top of the can 12, which is typically the same level as the dirt 16. In new installations, the hole for the sprinkler 10 is simply dug wide enough to accommodate the added space for the guard 32. In retrofit situations, the user will need to cut back the turf 18 and dig back the dirt 16 until there is adequate space for the guard 32.

As discussed previously, the trough 44 provides access to the clamp 34 from above the sprinkler 10, in the event that the guard 32 needs to be moved or otherwise maintained.

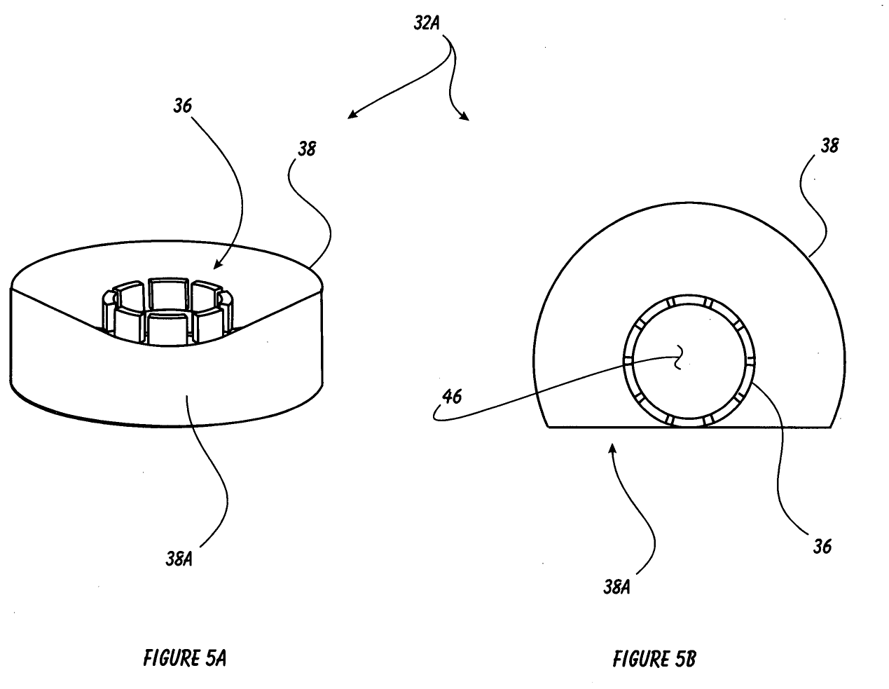

Since the turf 18 is now set back from the immediate proximity of the S sprinkler 10, the water spray produced by the sprinkler 10 upon initial activation will hit the sloped top surface rather than the turf 18. This will protect the turf 18 from damaging direct, high pressure spray. If the guard 32 is made from green plastic, it will add an aesthetically pleasing border around the sprinkler 10. Furthermore, the turf 18 will be easier to cut with a conventional lawn mower with less fear of damaging the sprinkler's head. If we now turn to FIGS. 5A and 5B, we can examine another version of the present invention.

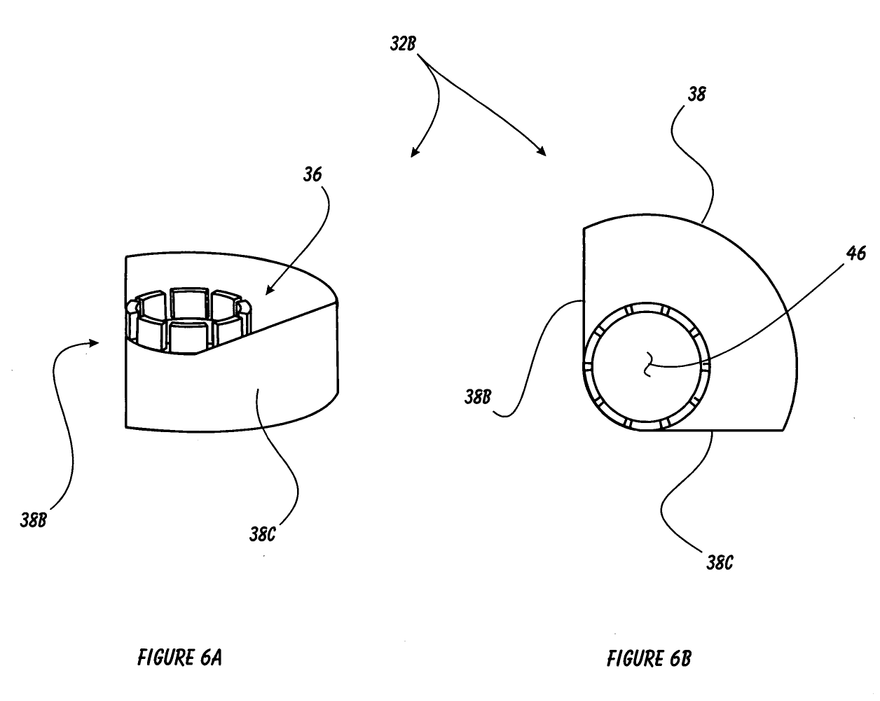

FIGS. 5A and 5B are top perspective and top views, respectively, of a semi-circle grass guard 32A of the present invention. Unlike the full-circle guard 32 depicted above, the semi-circle guard 32A does not have a circular outer wall 38. One portion of the outer wall 38A is flat, with the remainder of the wall 38 having a circular shape. The cutout portion permits the guard 32A to be installed on sprinklers that are next to a sidewalk, for example. Of course, the bore 46 and inner sleeve 36 have circular shapes in order to cooperate with the conventional sprinkler. As depicted in FIG. 5A, the flat portion of the outer wall 38A is sealed from the outside (i.e. rather than simply having a portion of the trough cut away)—this provides a more pleasing package. Finally turning to FIGS. 6A and 6B, we can look at yet another guard design and application.

FIGS. 6A and 6B are top perspective and top views, respectively, of a quarter-circle grass guard 32B of the present invention. This version is designed for installation where the sprinkler is adjacent to external structures (e.g. sidewalks) on two sides. This embodiment has a curved portion of the outer wall 38, it further has a first flat portion 38B and a second flat portion 38C at a ninety degree angle to the first flat portion 38B. As should be apparent from the top view of FIG. 6B, the quarter-circle grass guard 32B will fit snugly around a sprinkler without requiring much of a gap between the sprinkler and the sidewalks (for example).

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

1. A grass guard, comprising:
an inner sleeve;
a top surface extending radially from said sleeve; and
an outer wall extending from said top surface.

2. The guard of claim 1, wherein said inner sleeve is defined by a top end and a bottom end and further forms a bore therebetween, said top surface extending from said bottom end.

3. The guard of claim 2, wherein said top surface and said outer wall meet to form a top ridge.

4. The guard of claim 3, wherein said top surface is sloped downward from said top ridge to said bottom end.

5. The guard of claim 4, wherein said inner sleeve is further formed from a plurality of tabs extending upwardly from said bottom end.

6. The guard of claim 5, wherein said outer wall has a circular cross section.

7. The guard of claim 5, wherein said outer wall comprises a flat portion and a curved portion.

8. The guard of claim 7, wherein said outer wall further comprises a second flat portion.

9. The guard of claim 8, wherein said second flat portion is at a ninety degree angle to said first flat portion.

10. A device for attaching to below-ground sprinklers, said sprinklers having a subterranean can defining an outer circumference and a sprinkler assembly attached thereto, the device comprising:
an inner sleeve defining a bore formed therein to cooperate with said outer circumference such that said device can be slipped over said can;
a top surface extending radially from said sleeve; and
an outer wall extending from said top surface.

11. The guard of claim 10, wherein said inner sleeve is defined by a top end and a bottom end and further forms a bore therebetween, said top surface extending from said bottom end.

12. The guard of claim 11, wherein said top surface and said outer wall meet to form a top ridge.

13. The guard of claim 12, wherein said top surface is sloped downward from said top ridge to said bottom end.

14. The guard of claim 13, wherein said inner sleeve is further formed from a plurality of tabs extending upwardly from said bottom end.

15. The guard of claim 14, further comprising means for clamping said inner sleeve to said sprinkler.

16. The guard of claim 8, wherein said second flat portion is at a ninety degree angle to said first flat portion.

17. A combination sprinkler and grass guard comprising:
a sprinkler defined by a can and a sprinkler assembly attached thereto, said can defining an outer circumference; and
a guard attached to said sprinkler, said guard defined by an outer wall creating an interstitial gap around at least a portion of the outer circumference of said sprinkler.

18. The combination of claim 17, wherein said guard comprises:
an inner sleeve defining a bore formed therein to cooperate with said outer circumference such that said guard can be slipped over said can;
a top surface extending radially from said sleeve; and
an outer wall extending from said top surface.

19. The combination of claim 18, wherein said inner sleeve is defined by a top end and a bottom end and further forms a bore therebetween, said top surface extending from said bottom end.

20. The guard of claim 19, wherein said top surface is sloped downward from said top ridge to said bottom end.
